(19) United States
(12) Patent Application Publication
(10) Pub. No.: US 2009/0128398 A1
(43) Pub. Date: May 21, 2009

(54) Method of Calibrating a Sensor System

(76) Inventor: Oliver Wieland, Korntal-Muenchingen (DE)

Correspondence Address: KENYON & KENYON LLP, ONE BROADWAY, NEW YORK, NY, 10004, US

(21) Appl. No.: 12/087,252

(22) PCT Filed: Nov. 24, 2006
(86) PCT No.: PCT/EP2006/068865

§ 371 Date: Dec. 19, 2008

(30) Foreign Application Priority Data
Dec. 27, 2005 (DE) 10 2005 062 539.8

(51) Int. Cl. G01S 7/40

(52) U.S. Cl. 342/174

(57) ABSTRACT

A method for calibrating a sensor system having transmitters and receivers mounted on a vehicle at a distance from one another, and for measuring the distance of the vehicle from a roadway boundary, by a) sending a send signal at a first time, using a transmitter of the sensor system, b) converting the received send signal to a receive signal using a receiver of the sensor system, and establishing a second time at which the receive signal exceeds a certain threshold value, c) determining the propagation time of the send signal from the transmitter to the receiver from the difference in time between the second time and the first time, d) repeating a) to c) cyclically for a certain number of cycles, e) determining a frequency distribution of the propagation times determined in c), and f) generating a sensor distance value, which correlates with the sensor propagation time between the transmitter and the receiver, with the frequency distribution determined in e).

### FIELD OF THE INVENTION

The present invention relates to a method for calibrating a sensor system having transmitters and receivers mounted on a vehicle at a distance from one another, for measuring the distance of the vehicle from a roadway boundary, a method for recording the sensor condition of a sensor mounted on a vehicle, as well as a parking assistance system and a distance measuring device of a vehicle for measuring the distance of the vehicle from a roadway boundary.

### BACKGROUND INFORMATION

The increase in traffic density and more and more construction taking up free areas are reducing traffic space continuously, in particular in conurbation centers. The available parking space becomes tighter, and the search for a suitable parking space stresses the driver, in addition to ever increasing traffic. For that reason, among others, semiautonomous parking aid systems (SPA) have been developed, which are intended to support the driver during parking. The decision as to whether an available parking space is sufficient for a parking process is thereby made easier for the driver, or taken away from him altogether.

A series of different parking assistance systems is known; among these, for instance, parking assistance systems having a so-called “parking space surveying function”, which measure the size of a parking gap that the vehicle is passing, using short-range sensors mounted at the side of the vehicle. When the system detects a parking space that is big enough for the vehicle, this is signaled to the driver. During the subsequent parking process, the system gives the driver instructions or warning signals for parking.

The short-range sensors provided for parking gap surveying are, as a rule, developed as ultrasound sensors, having a range of up to a few meters. In this context, a plurality of ultrasound sensors is provided at the side of the vehicle. The exact position of the roadway boundary may then be ascertained by the principle of triangulation, with the aid of signals received from various sensors.

In this context, the various sensors may receive different types of signals, as is shown in FIG. 1. FIG. 1 shows several sensors 10a to 10d which are provided on the same side of a vehicle. The transmitted signals sent by the ultrasound sensors are reflected by an obstacle 11 and received again by the sensors. From the propagation time between the time of sending the transmitted signal and the time of receiving the signal reflected by obstacle 11, one may conclude the distance of the obstacle. In FIG. 1, a direct echo shown as a solid line denotes the case in which a transmitted pulse sent from a certain sensor (e.g. 10a) is also received again by this sensor (10a) after reflection at obstacle 11. By contrast, a cross echo shown as a dashed line in FIG. 1 denotes the case in which a transmitted pulse sent from a certain sensor (e.g. 10a) is received by another sensor (e.g. 10b, 10c or 10d) after reflection at obstacle 11. Crosstalk or direct crosstalk denotes the case in which a certain sensor (e.g. 10a) sends out a transmitted pulse, and this is directly received by one of the other sensors (e.g. 10b) without reflection at obstacle 11. This case is shown in FIG. 1 by dashed-dotted lines.

A serial pulse echo operation is known for avoiding mutual interferences of the sensors. New transmitted pulses are sent, in this instance, only after the decay (that is, after reception) of earlier transmitted pulses. In response to an increase in the maximum range of the sensors, the minimum distance between transmitted pulses therefore also has to increase, which runs counter to an also targeted reduction in the reaction times of the system.

To solve this problem, a stochastic coding was provided, as is shown schematically in FIG. 2. For this, FIG. 2 represents a series of transmitting and receiving events (“send” and “receive”) on a horizontal time line t. The vertical axis in FIG. 2 marks the distance A from the transmitters. By contrast to the serial pulse-echo operation, in stochastic coding there is no fixed sequence of sending the transmitted pulses and the receiving of the echo. The points in time at which the transmitted pulses are sent out are distributed stochastically. In FIG. 2, for instance, a second send event 22 that follows a first send event 21 takes place even before receive 23 of the first send pulse. The system has to assign one of send events 21 and 22 to receive event 23. This may also take place by a statistical evaluation of the receive signals, with the aid of which it may easily be ascertained that receive event 23 actually belongs to send event 21, and that consequently an obstacle may be suspected at a distance A′.

However, in stochastic coding, direct crosstalks have an interfering effect, since they are not able to be determined directly, but are only detectable after receiving and decoding the receive signal as well as classifying same (forming a histogram).

Therefore, in order to make possible a filtering of the crosstalks in the case of stochastic coding, the signal propagation times corresponding to the distances between the transmitters are ascertained manually by evaluating measuring data and are stored as constant parameters in a memory (e.g. an EEPROM). During operation, these signal propagation times are then read out of the memory in order to generate a filtering mask by which the direct crosstalks are able to be filtered out of the received signals.

This manual determination of the signal propagation times takes place at the plant, or, in the case of retrofitting of a parking assistance system, during the course of this retrofitting, which is connected with additional costs.

There is also the problem that, because of the temperature dependence of the speed of sound, the signal propagation times between the individual sensors are also temperature dependent. The speed of sound increases with increasing temperature, and thus brings about shorter signal propagation times. At extremely high or low temperatures, the actual signal propagation times no longer correspond to the values measured and stored before, so that the filter mask for filtering the direct crosstalks becomes ineffective. This may in turn lead to erroneous interpretations of the receive signal, and consequently to erroneous parking information to the driver.

### SUMMARY OF THE INVENTION

Accordingly, a method for calibrating a sensor system having transmitters and receivers mounted on a vehicle at a distance from one another is provided, for measuring the distance of the vehicle from a roadway boundary, having the steps of:
(a) sending a send signal at a first point in time (T1), using a transmitter of the sensor system;
(b) converting the received send signal to a receive signal using a receiver of the sensor system, and establishing a second point in time (T2) at which the receive signal exceeds a certain threshold value;
(c) determining the propagation time of the send signal from the transmitter to the receiver from the difference in time (T2−T1) between the second point in time (T2) and the first point in time (T1);
(d) repeating steps (a) to (c) cyclically for a certain number of cycles;
(e) determining a frequency distribution of the propagation times determined in step (c); and
(f) generating a sensor distance value which correlates with sensor propagation time between the transmitter and the receiver, with the aid of the frequency distribution determined in step (e).

The exemplary embodiments and/or exemplary methods of the present invention is based on undertaking an automatic calibration of the sensor system by determining the signal propagation times between the sensors from a frequency distribution.

One should understand a sensor system to mean a plurality of sensor units which are provided on at least one side of the vehicle at a distance from one another. These sensor units may be ultrasound sensors, in which case each sensor unit typically includes one (ultrasound) transmitter and one (ultrasound) receiver. In the following, a sensor unit including such transmitters and receivers will also be simply referred to as a “sensor”.

The sensor distance value may particularly be determined with the aid of a (local or global) maximum of the frequency distribution. The frequency distribution may, in particular, be a histogram, each value of the histogram being assigned to a certain propagation time.

In one advantageous refinement of the exemplary embodiments and/or exemplary methods of the present invention, the cyclical repetition of steps (a) to (c) is carried out repeatedly in a recursive manner, in each recursion the frequency distribution being scaled anew about the maximum of the frequency distribution H(n) of the preceding recursion. A decrease in the requirement for memory for the frequency distribution is achieved by such a recursive repetition of steps (a) to (c). By scaling we understand, in this instance, particularly the assignment of certain value ranges or measuring ranges to certain variables.

The method according to the present invention may be carried out particularly at each start of the vehicle and/or each switching on of a parking assistant provided in the vehicle. It may be ensured thereby that, upon commencement of the trip or rather upon switching on the parking assistant, the current sensor parameters are available, that is, particularly those corresponding to the outside temperature.

The method according to the present invention may be carried out at certain time intervals (e.g. every 10 minutes) during travel of the vehicle. Moreover, the method according to the present invention may also be carried out in response to changed environmental conditions, especially at a changed outside temperature. Thus, for instance, changes in direct crosstalks conditioned by temperature are compensated for, based on repeated measurement and calibration.

In one advantageous refinement of the exemplary embodiments and/or exemplary methods of the present invention, the following step is provided:
(g) the filtering out of direct crosstalks generated by the transmitter from a receive signal received by the receiver, while using the sensor distance value generated in step (f). Consequently, direct crosstalks may be filtered out while taking into consideration the current environmental parameters (in particular, environmental temperature).

It is advantageous in this instance, if the receive signal received by the receiver, from which the direct crosstalks generated by the transmitter are filtered out, corresponds to a send signal generated by the transmitter while using stochastic coding. A method is thus provided which makes possible the automatic calibration of transmitter-receiver systems which are operated on the basis of stochastic coding.

In the following, the exemplary embodiments and/or exemplary methods of the present invention is explained in greater detail with the aid of the exemplary embodiments shown in the schematic figures of the drawings.

### BRIEF DESCRIPTION OF THE DRAWINGS

FIG. 1 shows a schematic representation of the various signals which are able to be received by the sensors of a parking assistance system.

FIG. 2 shows a schematic representation of the principle of stochastic coding.

FIG. 3 shows a schematic diagram of a vehicle having a distance measuring device according to one specific embodiment of the present invention.

FIG. 4 shows a flow chart of a method for calibrating a sensor system, according to a first specific embodiment of the present invention.

FIG. 5 shows a histogram of the signal propagation times measured using the method in FIG. 4.

FIG. 6 shows a flow chart of a method for calibrating a sensor system, according to a second specific embodiment of the present invention.

FIGS. 7A, 7B and 7C show histograms of the signal propagation times measured using the method of FIG. 5.

FIG. 8 shows the signal propagation time of a sensor signal of a distance sensor as a function of time.

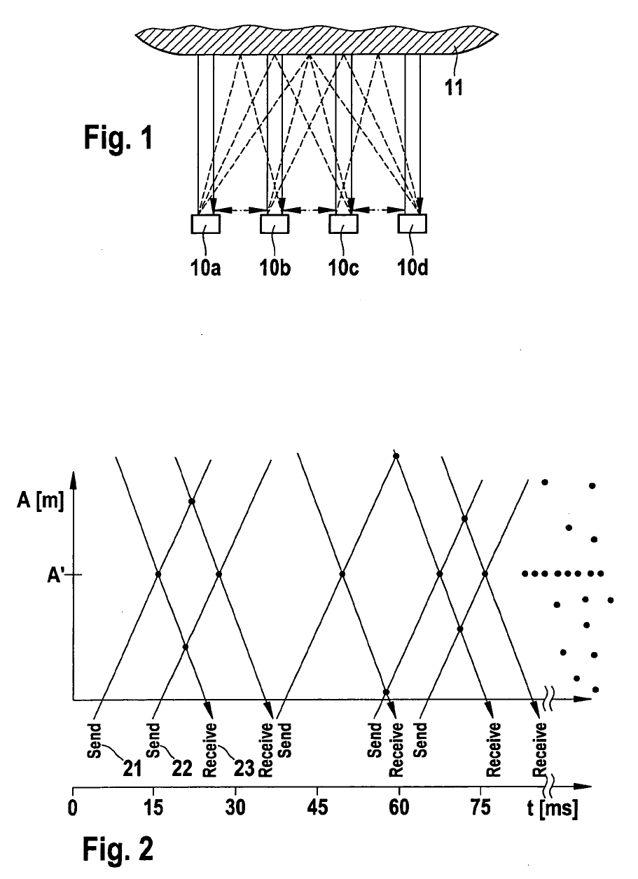

### DETAILED DESCRIPTION

Unless specifically mentioned otherwise, identical or functionally equivalent elements have been provided with the same reference numerals in the figures of the drawings.

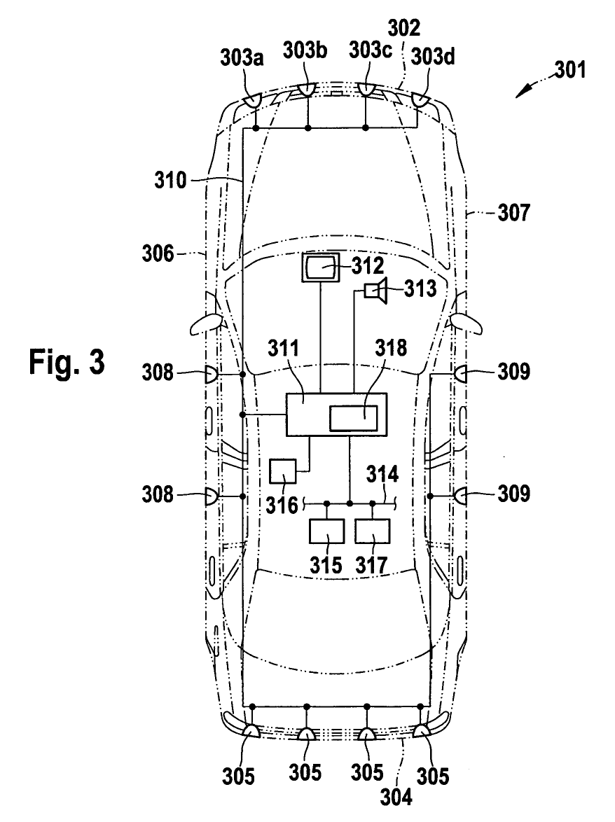

A motor vehicle 301 is schematically shown in FIG. 3. Distance sensors 303a-303d are situated at the vehicle's front end 302. Distance sensors 305 are also situated at rear end 304 of the vehicle. Lateral distance sensors 308 are provided at left side 306 of the vehicle. Lateral distance sensors 309 are provided at right side 307 of the vehicle. The distance sensors are used for measuring distances from obstacles in the vehicle's surroundings. In the present specific embodiment, distance sensors 303, 305, 308, 309 are developed as ultrasound sensors. They may also, however, measure distances based on another measuring principle, such as radar signals. Distance sensors 303, 305, 308, 309 supply their sensor signals via a data bus 310 to a program-controlled device 311 (for instance, a microprocessor, microcontroller or the like) having a memory 318 in vehicle 301. With the aid of the sensor signals supplied by distance sensors 303, 305, 308, 309, program-controlled device 311 ascertains distances from obstacles in the surroundings of the vehicle and the position of these obstacles in the surroundings of the vehicle. For the exact determination of the positions of the obstacles, program-controlled device 311 is able to make use of the principle of triangulation, the distance values ascertained by the various sensors being aligned with one another.

Furthermore, program-controlled device 311 is designed to ascertain a suitable parking space and possibly to determine a travel trajectory into this parking space. In this sense, program-controlled device 311 is also used as a parking assistant. Besides that, it may also determine outputs to the driver. For the output, program-controlled device 311 is connected to a warning signaling device that could be developed as a display 312 and/or a loudspeaker 313. Display 312 is particularly developed as a screen of a navigation display in the vehicle. Moreover, notices may also be output on an instrument cluster, a head-up display or via LED indicators which have to be mounted additionally on the dashboard. With the aid of display 312 or loudspeaker 313, notices may, for instance, be output which notify the driver, for example, that the vehicle has just passed a sufficiently large parking space.

In order to ascertain a movement or even the speed of the vehicle, program-controlled device 311 may be connected to at least one speed sensor 315 and one gear-shift sensor 317 via a data bus 314 that is particularly developed as a CAN bus. In one exemplary embodiment, speed sensor 315 is developed as a wheel speed sensor which measures a wheel motion of the vehicle. If a wheel motion is detected, the current speed of the vehicle is determined with the aid of the wheel rotation and the wheel circumference, as well as the course of time. From the current speed of the vehicle, and again in conjunction with the course of time, one can then conclude what was the route traveled.

Temperature sensor 316 measures the outside temperature and emits its measuring signal to program-controlled device 311.

### Method According to a First Specific Embodiment

In the following, we shall now explain a method for calibrating distance sensors according to a first specific embodiment of the present invention. To do this, we shall explain a calibration of sensor 303b with respect to direct crosstalk of sensor 303a.

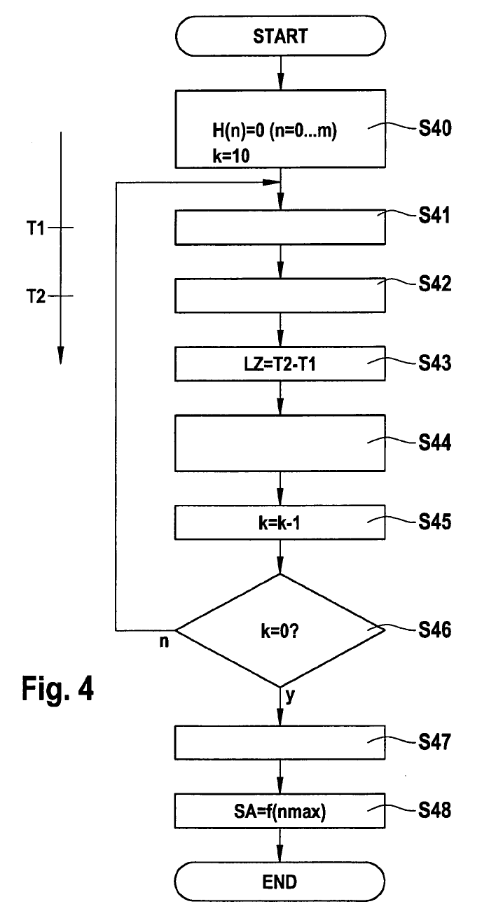

FIG. 4 shows a flow chart of a method for calibrating a sensor system, according to a first specific embodiment of the present invention. In this method, propagation times of the direct crosstalks of sensor 303a with sensor 303b in a plurality of measuring cycles is measured, and from these measured signal propagation times a histogram is formed.

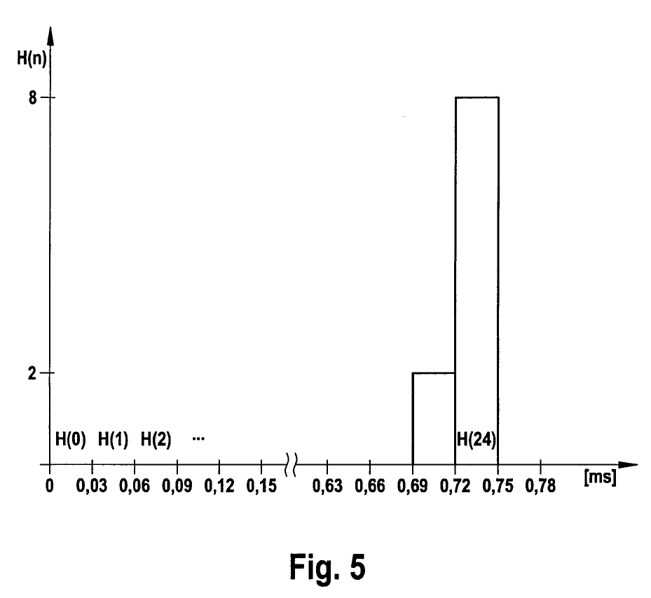

First of all, in step S40, initialization of the system is performed. First, variables H(0) . . . H(m) are set to zero (that is, H(n)=0, where n=0 . . . m, m+1 denoting the number of histogram points; a typical value for m being 99, for example). These variables correspond to the values H(n) of the histogram shown in FIG. 5. In this context, variable H(0) corresponds to a signal propagation time of 0.00-0.03 ms, variable H(1) to a signal propagation time of 0.03-0.06 ms, etc., and variable H(99) to a signal propagation time of 2.97-3.00 ms. It should be noted that a signal propagation time of 0.03 ms corresponds to a distance of about 1 cm. Each bar of the histogram H(n) thus represents a spatial distance of about 1 cm, it being noted that the exact spatial distances represented by the bars are a function of the speed of sound, and thus also a function of the temperature. Furthermore, in step S40 a counter variable k is set to 10. This counter variable is decremented after each send/receive step, so that altogether ten measuring cycles or iterations have to be carried out. All the variables in this specific embodiment are stored in memory 318 of program-controlled device 311.

At time T1 at step S41 a send pulse is transmitted using sensor 303a. The sound emitted by sensor 303a is picked up either directly or after reflection at an obstacle by sensor 303b in step S42, and is converted by an ultrasound transducer of sensor 303b into an electrical sensor signal. FIG. 8 shows a typical signal curve 80 of amplitude A over a time axis T. This signal curve 80 (receive signal) here corresponds to an envelope curve of the sensor signal generated by sensor 303b. First of all, signal curve 80 has a direct crosstalk 81 which reaches sensor 303b without reflections. An echo pulse (cross echo pulse) 82, reflected by an obstacle, appears at a time T3, this echo pulse 82 having a certain duration, up to an additional time T4. Times T2, T3 and T4 are specified using a threshold value 83 that is fixable, which corresponds to a certain amplitude value. Time T2 is defined, in this instance, as the time at which signal curve 80 exceeds threshold value 83 for the first time after time T1 of the sending of the signal pulse.

By evaluation of signal curve 80, program-controlled device 311 is thus able to ascertain the signal propagation time, that depends on the temperature, between sensors 303a and 303b, and is able to filter out direct crosstalk 81 from sensor signal 80, using a suitable filter.

Signal propagation time LZ, which is ascertained in step S43, is given by the temporal distance of times T2 and T1, that is: LZ=T2−T1. In the present example, there is a distance of 25 cm between sensors 303a and 303b, so that at a temperature of 20° C. there is a signal propagation time LZ of about 0.728 ms.

In step S44 the histogram is updated by incrementing variable H(n), that corresponds to the signal propagation time LZ, by 1. In this example, this is variable H(24), which is assigned to a distance in time of 0.72-0.75 ms.

In step S45, counter k is decremented by the value 1. If in step S46 counter k is equal to zero, the procedure jumps back to step S41, and steps S41 to S45 are repeated. Otherwise the procedure jumps to step S47. Consequently, steps S41 to S45 are repeated altogether 10 times.

FIG. 5 represents an example of the state of the histogram after a tenfold iteration. A signal propagation time of 0.72-0.75 ms was established eight times, in this instance, and a signal propagation time of 0.69-0.72 ms was established twice. This discrepancy may result from sensor inaccuracies or even from fluctuations in the measuring environment (such as temperature fluctuations, fluctuations of the sound level in the surroundings, etc.).

In step S47, program-controlled device 311 establishes the value nmax, at which the histogram assumes the maximum value. In other words, program-controlled device 311 ascertains the value nmax, for which H(nmax)=max(H(0), . . . , H(99)) applies.

In step S48, program-controlled device 311 generates a sensor distance value SA(=f(nmax)) with the aid of the value nmax, which corresponds to the ascertained sensor propagation time between sensors 303a and 303b. In the present example, this sensor distance value SA indicates that the sensor propagation time amounts to between 0.72 and 0.75 ms, which at a temperature of 20° C. corresponds to a distance of ca. 25 cm.

Consequently, with the closing of step S48, a state is produced which is present in the related art when the manual adjustment has been made at the factory. One advantage of the exemplary embodiments and/or exemplary methods of the present invention is therefore that the sensor calibration no longer has to be made by hand, which is thus more cost-effective. A further advantage is that the calibration may also be carried out periodically at certain intervals (e.g. once every 10 minutes). In addition, it is also possible to have a calibration go ahead automatically when temperature sensor 316 determines a change in the outside temperature by a certain amount (e.g. at least 3° K.). Thus, changes in the direct crosstalks that are conditional upon temperature are compensated for, based on the periodic measurement and calibration.

Clearly, the calibration is not restricted to the two sensors 303a and 303b, but is favorably carried out for all the sensors mounted on the vehicle, and their two-way direct crosstalks. The calibration for sensor pairs that do not influence one another may, in this instance, be carried out simultaneously, which leads to a saving of time. Thus, for instance, the calibration of sensors 309 may be carried out in time along with sensors 308, since sensors 308 and sensors 309 are on opposite sides of the vehicle, and there is therefore no direct crosstalks from sensors 308 to sensors 309, or vice versa.

### Method According to a Second Specific Embodiment

In the following, we shall now explain a method for calibrating distance sensor according to a second specific embodiment of the present invention. To do this, we shall explain again in an exemplary manner a calibration of sensor 303b with respect to direct crosstalk of sensor 303a.

In the method described above, according to the first specific embodiment of present invention, a separate variable is provided for each distance in time, that is, for each individual value of the histogram. The storage requirement that has to be made available in memory 318 is thus comparatively large, and it would be desirable to decrease this essential memory requirement by an appropriate adaptation of the method. This is achieved by the method according to the second specific embodiment.

The basic idea of this method is to carry out the method described above recursively, the respective variables H(n), which represent the histogram, standing in each recursion for different for different time interval widths.

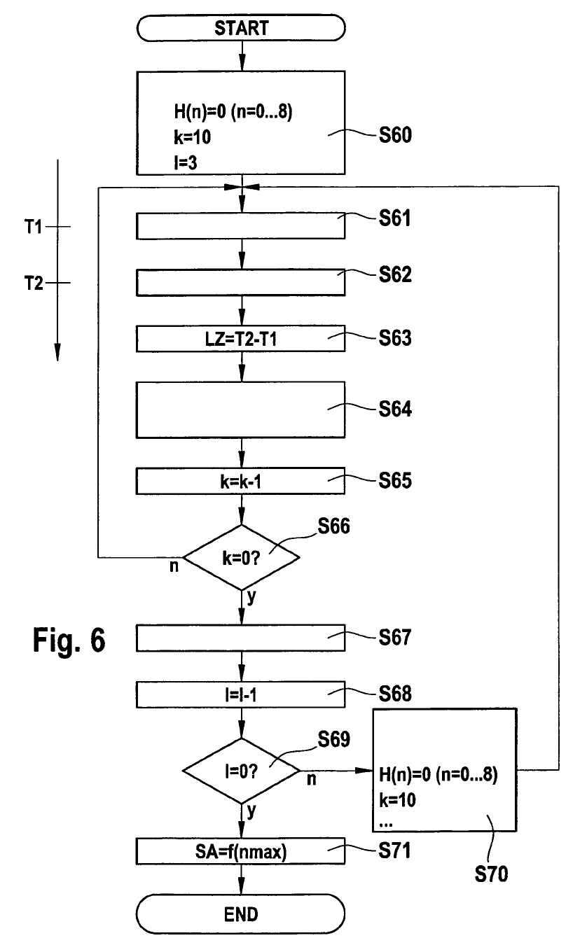

FIG. 6 shows a flow chart of a method for calibrating a sensor system, according to a second specific embodiment of the present invention. In this method, propagation times of the direct crosstalks of sensor 303a with sensor 303b in a plurality of measuring cycles is also measured, and from these measured signal propagation times a histogram is formed. However, by contrast to the method of the first specific embodiment, in this method only 9 variables H(0) . . . H(8) are provided for the histogram.

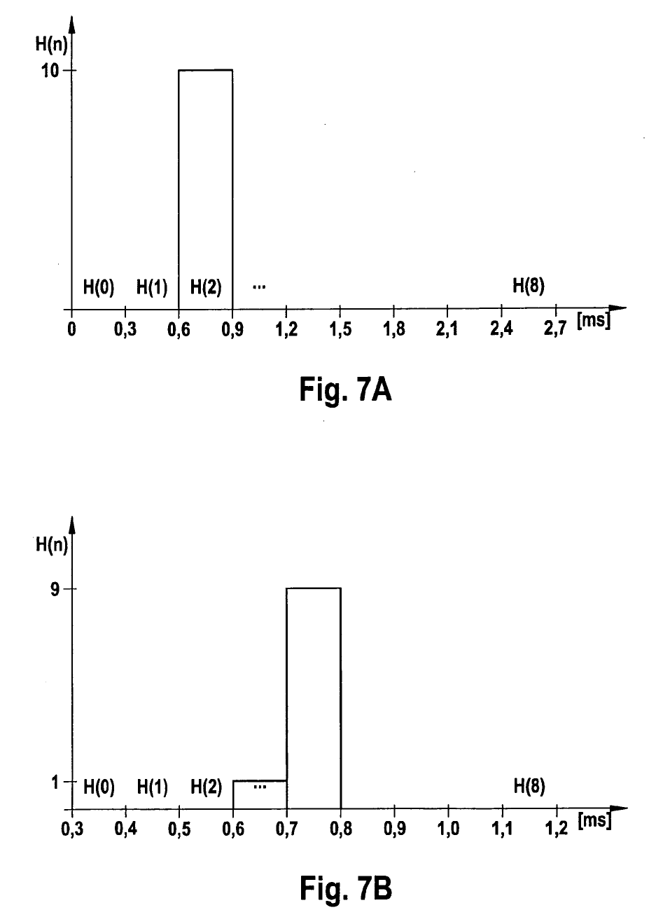

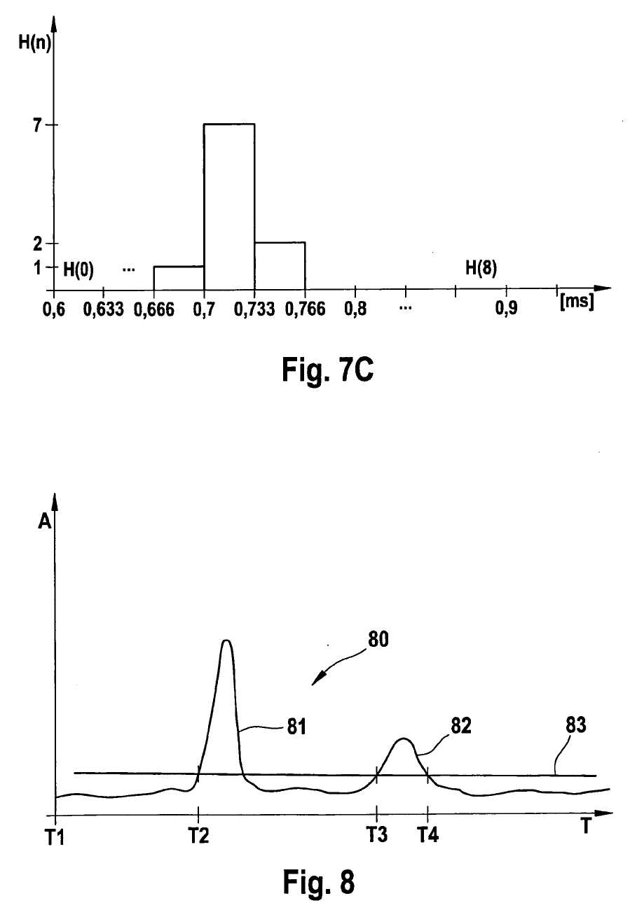

First of all, in step S60, initialization of the system is performed. First, variables H(0) . . . H(8) are set to zero (that is, H(n)=0, where n=0 . . . 8). These variables correspond to the values of the histogram shown in FIG. 7A. In this context, variable H(0) corresponds to a signal propagation time of 0.0-0.3 ms, variable H(1) to a signal propagation time of 0.3-0.6 ms, etc., and variable H(8) to a signal propagation time of 2.4-2.7 ms. It should be noted that a signal propagation time of 0.3 ms corresponds to a distance of about 10 cm. Each bar of the histogram therefore represents a spatial distance of about 10 cm. Furthermore, in step S60 a counter variable k is set to 10 and an additional counter variable 1 is set to 3 (for 3 recursions).

Steps S61 to S67 essentially correspond to steps S41 to S47, and are therefore only briefly sketched below.

At time T1 at step S61a send pulse is transmitted using sensor 303a. The sound emitted by sensor 303a in step S62 is picked up by sensor 303b, and is converted to an electrical sensor signal. In step S63 the signal propagation time LZ (=T2−T1) is ascertained. In the present example, there is a distance of 25 cm between sensors 303a and 303b, so that at a temperature of 20° C. there is a signal propagation time LZ of about 0.728 ms.

In step S64 the histogram is updated by incrementing variable H(n), that corresponds to the signal propagation time LZ, by 1. In this example, this is variable H(2), which is assigned to a distance in time of 0.6-0.9 ms.

In step S65, counter k is decremented by the value 1. If, in step S66, counter k is equal to 0, the procedure jumps back to step S61, and steps S61 to S65 are repeated. Otherwise the procedure jumps to step S67. Thus, steps S61 to S65 are repeated altogether 10 times in each recursion.

FIG. 7A represents an example of the state of the histogram in step S67, after the first recursion. A signal propagation time of 0.6-0.9 ms was established ten times, in this instance. In step S67, program-controlled device 311 establishes the value nmax, at which the histogram assumes the maximum value. In other words, program-controlled device 311 ascertains the value nmax, for which H(nmax)=max(H(0), . . . , H(8) applies. As may be seen in FIG. 7A, in the present example H(2)=10 applies, so that nmax=2.

In step S68, counter 1 is decremented by the value 1. In step S69, if the value of counter 1 is not 0, a further recursion of steps S61 to S68 is carried out. To do this, in step S70 there is a renewed initialization of the histogram, or rather of variables H(0) . . . H(8). In this case, all variables H(0) . . . H(8) are set to zero (that is, H(n)=0, where n=0 . . . 8). However, in the second recursion the assignment of the individual variables of the histogram changes in such a way that only those values are still considered which correspond to the measuring range of H(nmax−1) and H(nmax+1) of the first recursion, that is, the range of 0.3 to 1.2 ms. At the same time, a finer subdivision of the measuring ranges takes place, so that in this second recursion a measuring range of 0.1 ms width (that is, one third of the width of the measuring range in the first recursion) is assigned to each variable H(n).

This is illustrated in FIG. 7B, which shows an example of the state of the histogram in step S67 after the second recursion, nine measured values in the range of 0.7 to 0.8 ms being present and one measured value in the range of 0.6 to 0.7 ms being present.

In the third recursion there is a still finer subdivision of the measuring ranges, again in a third of the width of the measuring ranges in the second recursion, at a renewed centering about the measuring range, which corresponds to the value nmax that was ascertained in step S67. FIG. 7C represents an example of the state of the histogram in step S67, after the third recursion.

After the third recursion the value of counter 1 is decremented to 0 in step S68, and the procedure jumps from step S70 to step S71.

In step S71, with the aid of nmax (=f(nmax)) determined after the third recursion, program-controlled device 311 generates a sensor distance value SA which corresponds to the ascertained sensor propagation time between sensors 303a and 303b, while taking into consideration the measuring range to which this value nmax is assigned in the third recursion. In the present example, this sensor distance value SA indicates that the sensor propagation time amounts to between 0.700 and 0.733 ms, which at a temperature of 20° C. corresponds to a distance of ca. 25 cm.

In addition to the advantages of the method according to the first specific embodiment, in the method according to the second specific embodiment there is the substantial advantage that, compared to the first specific embodiment, there is a much lower requirement for memory storage (about one tenth).

As is also true in the first specific embodiment, the calibration may be carried out for all sensors and at the points in time given for the first specific embodiment.

Although the exemplary embodiments and/or exemplary methods of the present invention has been described above on the basis of the aforementioned exemplary embodiments, it is not limited thereto, but may be modified in various ways.

Thus, all given values as to numbers and ranges stated above are exemplary only, and may be modified or adjusted as required.

1-9. (canceled)

10. A method for calibrating a sensor system, having transmitters and receivers mounted on a vehicle, and which are at a distance from one another, for measuring a distance of the vehicle from a roadway boundary, the method comprising:
(a) sending a send signal at a first point in time by using a transmitter of the sensor system;
(b) converting a received send signal to a receive signal by using a receiver of the sensor system, and establishing a second point in time at which the receive signal exceeds a certain threshold value;
(c) determining a propagation time of the send signal from the transmitter to the receiver from a difference in time between the second point in time and the first point in time;
(d) repeating (a) to (c) cyclically for a certain number of cycles;
(e) determining a frequency distribution of the propagation times determined in (c); and
(f) generating a sensor distance value, which correlates with a sensor propagation time between the transmitter and the receiver, with the frequency distribution determined in (e).

11. The method of claim 10, wherein the sensor distance value is determined with a maximum of the frequency distribution.

12. The method of claim 10, wherein the frequency distribution is a histogram.

13. The method of claim 10, wherein the cyclical repetition of (a) to (c) is performed recursively a plurality of times, and wherein in each recursion, the frequency distribution is newly scaled about a maximum of the frequency distribution of a preceding recursion.

14. The method of claim 10, wherein the method is performed in response to at least one of a start of the vehicle and each switching on of a parking assistant in the vehicle.

15. The method of claim 10, wherein the method is performed at certain time intervals during travel of the vehicle.

16. The method of claim 10, wherein the method is performed during travel of the vehicle in response to at least one of a change in an environmental condition and a change in an outside temperature.

17. The method of claim 10, further comprising:
(g) filtering out direct crosstalks generated by the transmitter from a receive signal received by the receiver, while using the sensor distance value generated in (f).

18. The method of claim 17, wherein the receive signal received by the receiver, from which the direct crosstalks generated by the transmitter are filtered out, corresponds to a send signal generated by the transmitter while using stochastic coding.
